(19) United States
(12) Patent Application Publication
(10) Pub. No.: US 2008/0268220 A1
(43) Pub. Date: Oct. 30, 2008

(54) THERMAL INSULATIVE PRODUCT AND RELATED METHODS

(76) Inventor: Paul Olliges, Lake Stevens, WA (US)

Correspondence Address: TODD N. HATHAWAY, 119 N. COMMERCIAL ST. #620, BELLINGHAM, WA, 98225, US

(21) Appl. No.: 11/740,208

(22) Filed: Apr. 25, 2007

(51) Int. Cl. E04B 1/74; B32B 9/04; C09K 21/00

(52) U.S. Cl. 428/219; 252/601; 252/62; 34/284; 34/305; 425/472; 428/220; 428/34.1; 428/411.1

(57) ABSTRACT

Disclosed are thermal insulative compositions as well as materials, methods, and apparatus for producing thermal insulative compositions.

### BACKGROUND OF THE INVENTION

Many types of conventional thermal insulating materials are currently used for a variety of applications, including, for example, paper-based drinking cups and/or drinking cup sleeves, kitchen hot pads and/or mitts, building insulation, and the like. One type of conventional thermal insulating material in common use is synthetic foam, such as, e.g., polystyrene (also referred to as STYROFOAM®). At least one drawback of STYROFOAM®, however, is that it is a fossil-fuel-based material (i.e., petrochemical) and thus is not biodegradable.

Other materials, such as aerogel-based and biofoam insulating materials, have been developed in attempts to overcome some of the drawbacks associated with the manufacture and non-biodegradable nature of STYROFOAM®. Aerogel is a solid-state substance similar to a gel and having a low density because the liquid component is replaced with gas. Aerogel can be made from materials such as silica, alumina, chromia, tin, and carbon. Several aerogel-based insulating materials are described in U.S. Pat. Nos. 6,136,216 and 6,887,563. At least one drawback of aerogels is that, even though they are very lightweight and have good insulating properties, aerogels are produced under high temperature and pressure conditions, resulting in increased manufacturing costs.

Biofoam is a rigid, opaque foam made from materials derived from natural products and biological organisms. (See U.S. Pat. Nos. 5,360,828 and 5,382,285.) Typical naturally-derived materials include agar, agarose, gelatin, algin, alginates, gellan gum, and microcrystalline cellulose. The material is dissolved in a polar solvent, such as water, and the solution is gelled immediately. The gel is frozen and freeze-dried to form the biofoam. Alternatively, a nonpolar solvent is added to the solution and then the solution is emulsified to improve the homogeneity of the cell or pore size throughout the biofoam. The resulting emulsion is then gelled, frozen, and freeze dried. A variety of crystalline, fibrous, or metallic additives may be added to produce lightweight composite materials with enhanced strength and insulating properties. The density of the resulting biofoam ranges from about 1.0 mg/cm³ to about 500 mg/cm³. At least one drawback of biofoam is the different manufacturing process and materials combination, along with the use of potentially hazardous non-polar solvents, which leads to a potentially high manufacturing cost.

Some conventional thermal insulative materials include starch-based compositions, such as disclosed in, e.g., U.S. Pat. Nos. 5,035,930, 5,185,382, and 5,266,368. Other thermal insulative compositions primarily utilize fibrous materials in combination with a substantially lesser amount of stabilizing agents (e.g., starch), such as the aerated foam composition discussed in U.S. Pat. No. 5,612,385 to Ceasar et al.

### BRIEF SUMMARY OF THE INVENTION

In one aspect, the present invention provides a thermal insulative composition comprising from about 50% to about 90% by weight of one or more stabilizing agents; from about 10% to about 50% by weight of one or more fibrous materials; and from about 6% to about 10% by weight of one or more polar solvents. In one exemplary embodiment, the thermal insulative composition includes about 53% by weight of the one or more stabilizing agents; about 40% by weight of the one or more fibrous materials; and about 7% by weight of the one or more polar solvents. Typically, the thermal insulative composition has a density of from about 0.1 to about 0.5 g/cm³, more typically from about 0.1 to about 0.4 g/cm³. In a specific variation, the density of the composition is about 0.18 g/cm³.

In some embodiments, the one or more stabilizing agents of the composition includes a polysaccharide and/or a protein. Suitable polysaccharides include, for example, agars, alginates, pectins, carrageenans, and starches, while suitable proteins include, e.g., gelatin. The one or more fibrous materials can include, e.g., a naturally occurring fibrous material and/or a synthetic fibrous material. Naturally occurring fibrous materials can be either refined or unrefined and can include, e.g., softwood fibers, hardwood fibers, non-woody plant fiber, or animal fibers. Suitable non-woody plant fibers include, for example, cotton fibers, jute fibers, flax fibers, ramie fibers, bamboo fibers, bagasse fibers, kenaf fibers, straw fibers, arundo donax fibers, and hemp fibers. Synthetic fibers suitable for use with the invention include, for example, carbon fibers, polyester fibers, nylon fibers, rayon fibers, glass fibers, or aramid fibers. The one or more polar solvents typically include an alcohol and/or water.

Optionally, the thermal insulative composition comprises up to about 2% by weight of one or more foaming agents. The one or more foaming agents can include, for example, an anionic surfactant (e.g., a soap or fatty acid salt), a cationic surfactant, and/or a nonionic surfactant. In certain embodiments, the thermal insulative composition does not comprise a foaming agent.

The thermal insulative composition also optionally comprises from about 0.1% to about 5% by weight of one or more additives. The one or more additives can include, for example, a wet strength additive, a dry strength additive, a water repellant, a glue, a chemical foaming agent, a fungicide a fire retardant, a dye, and/or a sizing agent.

In particular embodiments, the thermal insulative composition is a molded composition or a sheet composition. Such variations can further include a coating and/or a printing applied to a surface of the composition. Suitable coatings include, e.g., polyethylene extrusion or wax coatings. In the case of a sheet composition, the composition can be, for example, incorporated as the insulative ply of a multi-ply structure comprising an insulative ply and at least one other ply (e.g., the insulative ply of a two-ply structure comprising an insulative ply and a base ply; or the center insulative ply of a three-ply structure comprising a center insulative ply and two outer base plies). Particularly suitable base plies include, for example, paper or paperboard. Thermal insulative sheet compositions of the present invention can have a thickness of, e.g., between about 0.5 mm and about 150 mm or between about 1 mm and about 4 mm. Sheet compositions of the invention typically have a nominal weight of from about 100 to about 400 g/m², more typically from about 150 to about 300 g/m².

In certain preferred embodiments, thermal insulative composition is an alterable stiffness insulative material. In some such variations, the thermal insulative composition is a sheet composition, such as a sheet produced on a continuous run machine and has a machine direction (MD) and a cross direction (CD). Alterable stiffness sheet compositions having an MD and CD can include, for example, sheets having a taber stiffness of between about 100 to about 450 g-cm in the machine direction and between about 40 to about 230 g-cm in the cross direction. Particular alterable stiffness characteristics of some thermal insulative sheet compositions include, e.g., any one of the following:
(a) an MD stiffness of between about 110 and about 160 g-cm with a CD stiffness of between about 50 and about 80 g-cm;
(b) an MD stiffness of between about 120 and about 180 g-cm with a CD stiffness of between about 55 and about 95 g-cm;
(c) an MD stiffness of between about 150 and about 215 g-cm with a CD stiffness of between about 60 and about 105 g-cm;
(d) an MD stiffness of between about 185 and about 250 g-cm with a CD stiffness of between about 75 and about 125 g-cm;
(e) an MD stiffness of between about 210 and about 280 g-cm with a CD stiffness of between about 85 and about 150 g-cm;
(f) an MD stiffness of between about 260 and about 360 g-cm with a CD stiffness of between about 105 and about 185 g-cm; and
(g) an MD stiffness of between about 340 and about 450 g-cm with a CD stiffness of between about 135 and about 230 g-cm.

Thermal insulative compositions of the invention, particularly thermal insulative sheet compositions, are suitable, e.g., for the production of thermal insulative containers or container sleeves. In certain preferred variations, thermal insulative containers or container sleeves have alterable stiffness characteristics as set forth above.

In other aspects, the present invention provides materials that can be used for producing a thermal insulative composition as described herein. In one aspect, a wet fibrous composition is provided that includes from about 4% to about 7% by weight of one or more stabilizing agents; from about 1% to about 4% by weight of one or more fibrous materials; and from about 90% to about 95% by weight of one or more polar solvents. In a specific variations, the wet composition includes about 4% by weight of the one or more stabilizing agents; about 3% by weight of the one or more fibrous materials; and about 93% by weight of the one or more polar solvents. The fibrous wet composition can further include up to about 2% by weight of one or more foaming agents and/or from about 0.1% to about 5% by weight of one or more additives. In particular embodiments, the fibrous wet composition does not include a foaming agent. Suitable stabilizing agents, fibrous materials, polar solvents, foaming agents, and additives are as described herein with respect to thermal insulative compositions of the invention.

In certain embodiments, the wet fibrous composition is provided in a substantially unaerated form. In other embodiments, the wet fibrous composition is aerated, having a volume of gas equal to from about 20% to about 70% by volume. The density of such an aerated wet fibrous composition is typically from about 0.7 to about 0.3 g/cm³.

In yet another aspect, the present invention provides a method of making a thermal insulative composition as described herein. Generally, the method includes drying an aerated wet fibrous composition as described above to a polar solvent content of from about 6% to about 10% by weight. Typically, the aerated wet composition is dried to a density of from about 0.1 to about 0.5 g/cm³. Drying of the wet composition can include, for example, any one or more of air drying, convection oven drying, and freeze drying.

In particular embodiments of the method for producing a thermal insulative composition, the method further includes making the aerated wet fibrous composition. Production of the aerated wet composition generally includes dispersing the one or more stabilizing materials and the one or more fibrous materials in the one or more polar solvents to produce a fibrous wet composition; and incorporating air into the fibrous wet composition. Incorporation of air into the wet composition can include, for example, the use of one or more foaming agents. In an alternative embodiment, the incorporation of air includes mechanically inducing air into mixture.

In specific variations for making the wet fibrous composition, dispersal of the fibrous materials and stabilizing agents in the polar solvents includes (a) dispersing the one or more fibrous materials in the one or more polar solvents to produce a fibrous material/polar solvent mixture; (b) heating the mixture of (a); and (c) between the beginning and end of the heating step of (b), continually mixing and/or applying pressure to the mixture of (a) while dispersing into the mixture the one or more stabilizing agents. In such variation, the incorporation of air into the fibrous wet composition can include, for example, dispersing one or more foaming agents into the one or more polar solvents before or during step (c) and agitating and/or releasing pressure from the heated mixture of (c).

In some embodiments, a method of producing the thermal insulative composition further includes injecting the aerated wet composition into a mold before the drying step, thereby producing a molded composition. In one alternative embodiment, the drying of the aerated wet composition further includes forming the composition into a sheet. Such embodiments can also include, for example, applying a coating and/or printing to the molded or sheet composition. Suitable coatings include, e.g., polyethylene extrusion and/or wax coatings.

In variations for forming a sheet composition, the drying can include, e.g., any one or more of air drying, convection oven drying, dryer can drying, impingement drying, and freeze drying. In specific embodiments, a method for forming a sheet composition also includes incorporating the sheet composition as the insulative ply of a two-ply structure comprising an insulative ply and a base ply, or as the center insulative ply of a three-ply structure having a center insulative ply and two outer base plies. Particularly suitable base plies include, e.g., paper and paperboard.

In some preferred embodiments for forming a thermal insulative sheet composition, the forming of the aerated wet composition into a sheet includes running the aerated wet composition through a twin-wire forming apparatus. The twin-wire forming apparatus typically includes first and second forming wire sections comprising first and second forming wires, respectively, and a gap between the first and second forming wires. Preferably, the gap gradually decreases from a proximal end to a distal end of the twin-wire forming apparatus (a “proximal end” of a twin-wire forming apparatus generally refers to an end in which the aerated wet composition is fed into the apparatus). Typically, such methods also include applying a vacuum perpendicularly to each of the first and second forming wires, such that the aerated wet composition is pulled against each of the first and second forming wires, thereby compressing the aerated wet composition into first and second layers against each of the first and second forming wires, respectively. Generally, the first and second layers will have a higher density relative to the aerated wet composition remaining between the first and second layers.

In some embodiments comprising formation of a sheet composition, the method further includes forming at least a portion of the sheet into a substantially cylindrical shape. Such forming can include, for example, wrapping the sheet around a substantially cylindrical mandrel.

In still another aspect, the present invention provides an apparatus for forming a sheet composition having a high bulk interior and a surface finish on both sides. Generally, the apparatus has a proximal end and a distal end and includes first and second forming wire sections comprising first and second forming wires, respectively. The first and second forming wires have a continuous wire direction from the proximal end to the distal end, and the inner surfaces of the first and second forming wires are spaced from each other so as to define a gap between the forming wires. The gap between the first and second forming wires is typically from about 0.5 mm to about 150 mm or from about 0.5 mm to about 20 mm. In certain preferred embodiments, the gap gradually decreases from the proximal end to the distal end. For example, in some variations, the gap between the first and second forming wires is from about 10 mm to about 25 mm at the proximal end and from about 4 mm to about 8 mm at the distal end. In a specific embodiment, the gap is about 12 mm at the proximal end and about 6 mm at the distal end.

The first forming wire section can be fixed and the second forming wire section movable so as to allow the gap between the first and second forming wires to be increased or decreased. Alternatively, each of the first and second forming wire sections is movable so as to allow the gap between the first and second forming wires to be increased or decreased.

Preferably, the twin-wire forming apparatus also comprises means for subjecting the gap to opposing vacuum forces. Typically, such means includes a first vacuum configured to pull perpendicularly toward a surface of the first forming wire and a second vacuum configured to pull perpendicularly toward a surface of the second forming wire.

### BRIEF DESCRIPTION OF THE DRAWINGS

FIG. 1 is an isometric view of an insulative product comprising a cup and/or cup sleeve.

FIG. 2 is an isometric view of the cup sleeve of FIG. 1.

FIG. 3 is a flowchart depicting a method of making an aerated fibrous wet composition, which is then processed to make a thermal insulative composition.

FIG. 4 is a flowchart depicting two particular embodiments for processing an aerated fibrous wet composition (as depicted in FIG. 3) into a thermal insulative composition (namely, either a molded composition or a sheet composition).

FIG. 5 depicts a twin wire forming apparatus, which can be used to form a sheet composition from an aerated fibrous wet composition.

### DETAILED DESCRIPTION OF THE INVENTION

The present invention is generally directed to thermal insulative compositions, as well as materials, methods, and apparatus for producing such compositions. The thermal insulative composition generally comprises one or more stabilizing agents in combination with one or more fibrous materials and one or more polar solvents, where the stabilizing agent(s) constitute at least about an equal percentage of the composition by weight, and typically a greater percentage of the composition by weight, as compared to the fibrous material(s). In some aspects of the invention, the use of at least an equal or greater amount of stabilizing agents as compared to fibrous materials allows for decreased production costs relative to conventional insulative compositions and methods. Further, the use of less fibrous materials allows for incorporation of more air in the thermal compositions, thereby providing greater insulative properties.

Generally, stabilizing agents are agents that aid in the structural formation of the composition, such as, for example, in the bonding between fibrous material constituents, or between a fibrous material and other constituents, if present in the composition. During formation of a thermal insulative composition as described herein, a stabilizing agent, when mixed with one or more fibrous materials and one more polar solvents to create a fibrous wet composition, will increase the viscosity of the fibrous wet composition relative to a corresponding fibrous wet composition lacking the stabilizing agent. A variety of stabilizing agents amenable for use with insulative compositions are well-known in the art and can be used in accordance with the compositions and methods of the present invention. Suitable stabilizing agents include, for example, polymers such as polysaccharides and proteins. Particularly suitable polysaccharide stabilizing agents include, e.g., agars, alginates, pectins, carrageenans, and starches. Particularly suitable protein stabilizing agents included, e.g., gelatins. In accordance with the present invention, the percentage of the stabilizing agent(s), by weight of the thermal insulative composition, is from about 50% to about 90%, typically from about 50% to about 80%, and more typically from about 50% to about 70% or from about 50% to about 60%.

A “fibrous material,” as referred to herein, is a material comprising a fiber, i.e., a slender and elongated filament, which generally provides structural reinforcement for the insulative product. The fibrous material can be naturally occurring or synthetic. In certain variations of the invention, both natural and synthetic fibrous materials are used. Naturally occurring fibrous materials can be either refined or unrefined and include, for example, softwood fibers, hardwood fibers, non-woody plant fibers, and animal fibers. Suitable non-woody plant fibers for use in accordance with the present invention include, e.g., cotton, jute, flax, ramie, bamboo, bagasse, kenaf, straw, arundo donax, and hemp; suitable animal fibers include, e.g., silk and wool. Suitable synthetic fibers include, for example, carbon, polyester, nylon, rayon, glass, and aramid fibers. Various combinations of any of the above fibrous materials may also be used.

The polar solvent(s) of the thermal insulative composition operates as a medium in which other constituents (e.g., stabilizing agent and fibrous material) interact. “Polar solvents” are generally understood to have a molecular structure with larger dipole moments and high dielectric constants, in contrast to the relatively low dipole moments and small dielectric constants of non-polar solvents. On an operational basis, solvents that are miscible with water are polar, while those that are not are non-polar. Suitable polar solvents for use in accordance with the present invention include, e.g., water and alcohol. In one embodiment, the water is not 100% pure, but does have a low turbidity and is non-toxic. Alcohol is particularly suitable, e.g., in certain specialized applications. For example, one benefit of alcohol is that it has a boiling point that is lower than the boiling point of water and thus requires less energy to remove from a fibrous wet composition during the drying process to produce the thermal insulative composition. Typically, the percentage of polar solvent(s) by weight of the thermal insulative composition is in the range of about 5% to about 11%, more typically from about 6% to about 10%, and even more typically from about 7% to about 9%.

In certain embodiments, the thermal insulative composition further includes one or more foaming agents. Foaming agents are responsible for aiding in the encapsulation of air when the various constituents of the thermal insulative composition are combined. Upon aeration, the constituents generate a foam, which confers certain insulative properties to the composition. As an alternative, air may be encapsulated into the composition in the absence of a foaming agent, as described further herein. Also, foamable materials may be used instead of a foaming agent.

Suitable foaming agents include, for example, anionic surfactants (e.g., soaps or fatty acids), cationic surfactants, and/or nonionic surfactants. These foaming agents operate by reducing the surface tension between the molecules of the various constituents as the constituents are agitated during the creation of the thermal insulative composition. As foam is generated, the foaming agent operates to facilitate the entrainment of a gas, such as air, into the composition. Typically, where a foaming agent is present in the thermal insulative composition, the composition includes up to about 5% by weight of one or more foaming agents, more typically up to about 1% or up to about 2% by weight of one or more foaming agents.

Optionally, the thermal insulative composition further includes an additive. Additives are additional materials that can be added to the thermal insulative composition to optimize or improve certain aspects or characteristics of the composition, or to customize the composition or make the insulative composition usable for a particular application. Additives that may be included in the thermal insulative composition can be selected from a wide variety of materials, such as materials for enhancing the strength of the wet composition before drying (wet-strength additives); materials for enhancing the strength of the dry insulative product (dry-strength additives); glues, water repellants, chemical foaming agents that decompose under elevated temperatures and release a gas, fungicides, fire retardants, dyes, and sizing agents (e.g., to improve ink hold out an printability). The composition can include up to about 15% by weight of one or more additives. In certain embodiments, the composition includes up to about 5% by weight of one or more additives.

The thermal insulative composition of the present invention can be used in a wide variety of forms and applications. In particular embodiments, the thermal insulative composition is a molded composition or a sheet composition. Such molded or sheet compositions can include, for example, a coating and/or printing applied to a surface of the composition. Suitable coatings include, for example, a polyethylene extrusion or a wax coating. As used herein, “sheet composition” refers to a relatively thin, substantially flat composition, irrespective of length (for example, sheets can include longer rolls or relatively short pieces of material) or two-dimensional shape (e.g., sheets can include rectangular pieces of material as well as other shapes). Sheet compositions of the present invention typically have a thickness of from about 0.5 mm to about 150 mm, more typically from about 0.5 mm to about 10 mm, from about 1 mm to about 10 mm, from about 1 mm to about 8 mm, from about 1 mm to about 4 mm, or from about 2 mm to about 4 mm.

In some embodiments, a sheet composition is the insulative ply of a multi-ply structure comprising an insulative ply and at least one other ply. For example, in specific variations, the sheet composition can be the insulative ply of a two-ply structure comprising an insulative ply and a base ply; or the center insulative ply of a three-ply structure comprising a center insulative ply and two outer base plies. Suitable base plies include, e.g., paper or paperboard. Sheet compositions are useful, for example, in the production of thermal insulative containers or container sleeves (e.g., thermal insulative cups or cup sleeves).

In some preferred embodiments, the thermal insulative composition has an alterable stiffness. Generally, the nature and proportion of stabilizing agent(s) used will determine the stiffness. For example, increasing the proportion of stabilizing agent (e.g., starch) relative to the fibrous material used, by weight of the composition, will generally increase the stiffness of the thermal insulative composition. As will be appreciated by the skilled artisan, where the thermal insulative composition is a sheet composition produced on a continuous run machine, stiffness will vary in the machine run direction (“machine direction”) relative to across the run (“cross direction”). A standard measurement of stiffness is taber stiffness (modulus multiplied by cube of thickness, typically expressed in units of gram-centimeters (g-cm)). Typically, the taber stiffness of the thermal insulative composition is between about 100 to about 450 g-cm in the machine direction (MD) and between about 40 to about 230 g-cm in the cross direction (CD). Exemplary ranges of taber stiffness for a sheet composition of the present invention are set forth in Table 1 below.

TABLE 1
Exemplary Taber Stiffness Ranges for Sheet Composition

| | | |
|---|---|---|
| Increasing | | |
| Stiffness | MD (g-cm) | CD (g-cm) |

| from A to G | Min | Max | Min | Max |
|---|---|---|---|---|
| A | 110 | 160 | 50 | 80 |
| B | 120 | 180 | 55 | 95 |
| C | 150 | 215 | 60 | 105 |
| D | 185 | 250 | 75 | 125 |
| E | 210 | 280 | 85 | 150 |
| F | 260 | 360 | 105 | 185 |
| G | 340 | 450 | 135 | 230 |

Typically, the thermal insulative composition of the present invention has a density of from about 0.1 to about 0.5 g/cm³, preferably from about 0.1 to about 0.4 g/cm³. In a specific variation, the thermal insulative composition has a density of about 0.2 g/cm³. The nominal weight of the composition is typically from about 100 to about 400 g/m², preferably in the range of from about 150 to about 300 g/m².

In certain variations of sheet compositions suitable for use in production of insulative cup stock and/or cup sleeves, the targeted stiffness of the thermal insulative composition is focused towards replacement of current cup stock material, with the targeted nominal weight being focused toward about 60% to about 75% (typically about two thirds or about 65% to 70%) of the basis weight of the current cup stock material to be replaced. An example of current cup stock specifications is set forth below in Table 2.

TABLE 2
GP Crossett Cup Stock Specifications

| | | | | | Taber Stiffness (g-cm) | | | |
|---|---|---|---|---|---|---|---|---|
| | Caliper (mil) | | | Nominal | MD | | CD | |
| Grade | Target | Min | Max | Weight (g/m²) | Target | Min | Target | Min |
| HCC162 | 14.0 | 13.0 | 15.0 | 162 | 150 | 110 | 70 | 50 |
| HCC171 | 15.0 | 14.0 | 16.0 | 171 | 170 | 120 | 85 | 55 |
| HCC180 | 16.0 | 15.0 | 17.0 | 180 | 200 | 150 | 95 | 60 |
| HCC190 | 17.0 | 16.0 | 18.0 | 190 | 230 | 185 | 110 | 75 |
| HCC198 | 18.0 | 17.0 | 19.0 | 198 | 260 | 210 | 135 | 85 |
| HCC217 | 20.0 | 19.0 | 21.0 | 217 | 340 | 260 | 170 | 105 |
| HCC234 | 22.0 | 21.0 | 23.0 | 234 | 430 | 340 | 215 | 135 |

A composition according to the present invention has positive insulating attributes (e.g., low thermal conductivity) and is thus useful in the production of various insulative products, including, e.g., thermal insulative containers and container sleeves. For example, for a composition of the invention comprising about 53% starch, about 40% fiber, and about 7% water, and having a density of about 0.2 g/cm³, the insulating properties of two samples (1227062A and 1227062B) of a 2 mm thick sheet relative to standard market paper coffee cups is represented below in Table 3.

TABLE 3
Insulative Properties of Exemplary Thermal Sheet Composition

| | Interior | | | |
|---|---|---|---|---|
| | Surface | Exterior | ΔTemp. | % Change |
| | Temp. | Surface Temp. | (Interior minus | in |
| Container Type | (° F.) | (° F.) | Exterior) | Temp. |
| Generic paper | 175 | 158 | 17 | −9.71% |
| coffee cup | | | | |
| Starbucks paper | 175 | 160 | 15 | −8.57 |
| coffee cup | | | | |
| Starbuck cup | 175 | 131 | 44 | −25.14% |
| with sleeve | | | | |
| Sample | 175 | 137 | 38 | −21.71 |
| 1227062A | | | | |
| Sample | 175 | 135 | 40 | −22.86 |
| 1227062B | | | | |

The target surface temperature that allows a hand to hold a container is in the range of about 130 to about 138° F. As shown in Table 3 above, this target range can be achieved with thermal insulative compositions according to the invention. Furthermore, in the particular case of cups comprising the thermal insulative composition samples described above, the insulative properties of a cup in the absence an insulative sleeve are roughly equivalent to the Starbuck cup with a sleeve.

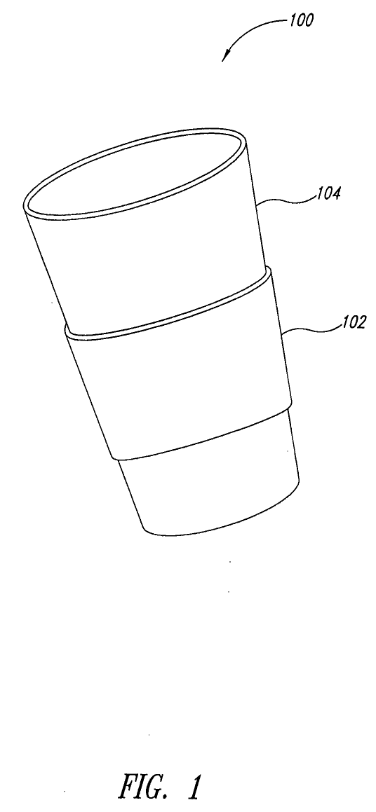

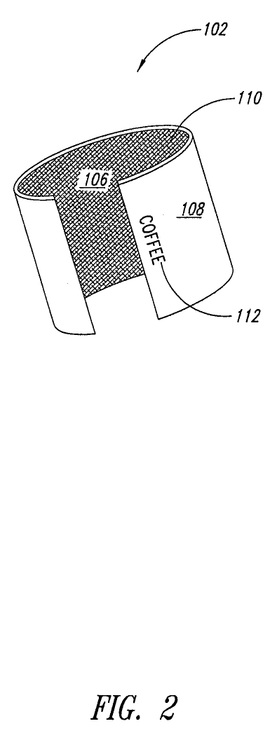

Accordingly, in a related aspect, the present invention provides a thermal insulative container or container sleeve (e.g., an insulative cup or cup sleeve) comprising a thermal insulative composition as described herein. In certain variations, a thermal insulative container or sleeve comprises a sheet composition as set forth herein. Particular embodiments of a thermal insulative cup and sleeve are depicted in FIGS. 1 and 2. FIG. 1 shows a product 100 comprising a sleeve 102 positioned on a cup 104. At least one or both of the sleeve 102 and/or the cup 104 are made from a thermal insulative sheet composition as described herein. FIG. 2 shows the insulative product comprising the sleeve 102 formed from a portion of an insulative sheet and rolled to have an inner surface 106 and an outer surface 108. Some of the fibrous material 110 may be visible on the inner surface 106. Typically the outer surface 108 and the inner surface 110 have a smooth, printable surface finish where printed matter 112 can be crisply and cleanly placed on either or both surfaces.

In yet other aspects, the present invention provides materials and methods for producing a thermal insulative composition as described herein. In one particular aspect, the present invention provides a fibrous wet composition (also referred to herein as “wet composition”) for producing the thermal insulative composition. Typically, the wet composition comprises from about 4% to about 7% by weight of one or more stabilizing agents; from about 1% to about 4% by weight of one or more fibrous materials; and from about 90% to about 95% by weight of one or more polar solvents. In a particular embodiment, the wet composition is aerated, comprising a volume of gas equal to from about 20% to about 70% by volume. Such an aerated fibrous wet composition will typically have a density of from about 0.8 g/cm³ to about 0.3 g/cm³, more typically from about 0.7 g/cm³ to about 0.3 g/cm³ or from about 0.5 g/cm³ to about 0.3 g/cm³. Optionally, the wet composition further includes up to about 2% by weight of one or more foaming agents, typically used to facilitate incorporation of gas to yield an aerated wet composition. Suitable stabilizing agents, fibrous materials, polar solvents, and foaming agents are described above in the context of the thermal insulative composition. In a specific variation, the aerated fibrous wet composition includes about 4% by weight of stabilizing agent(s), about 3% by weight of fibrous material(s); and about 93% by weight of polar solvent(s).

A method of making a thermal insulative composition generally includes processing an aerated fibrous wet composition as described above to yield the thermal insulative composition. Processing of the aerated wet composition includes drying the wet composition to a polar solvent content of from about 6% to about 10% by weight. Typically, the aerated wet composition is dried to a density of from about 0.1 to about 0.5 g/cm³. The drying step can include air drying, convection oven drying, and/or freeze drying.

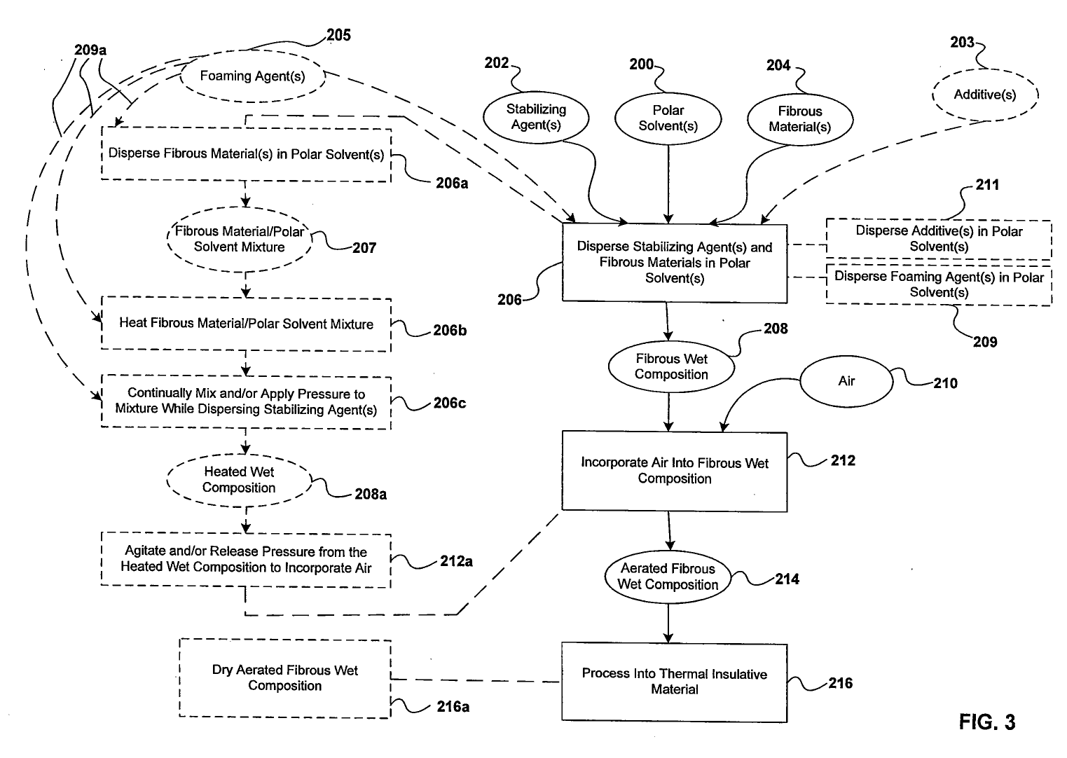

An embodiment of the method is schematically depicted in FIG. 3. This embodiment includes making the aerated fibrous wet composition. As shown in FIG. 3, step 206 includes dispersing stabilizing agent(s) 202 and fibrous materials 204 into polar solvent(s) 200 to yield a fibrous wet composition 208. Optionally, any desired additives 203 and/or desired foaming agent(s) 205 can also be dispersed into the polar solvent(s) (optional steps 211 and 209, respectively). The dispersing step 206 can include, for example, dispersing the fibrous materials 204 in the polar solvent(s) 200 to produce a fibrous material/polar solvent mixture 207 (substep 206a); heating the fibrous material/polar solvent mixture (substep 206b); and, between the beginning and end of the heating step, continually mixing and/or applying pressure to the fibrous material/polar solvent mixture while dispersing into the mixture the stabilizing agent(s) 202 (substep 206c), thereby producing the fibrous wet composition 208 (shown as “heated wet composition 208a”).

At step 212, air 210 is incorporated into wet composition 208 to yield the aerated fibrous wet composition 214. As indicated above, incorporation of air into wet composition 208 can include the use of one or more foaming agents 205, which are also dispersed in the one or more polar solvents (shown as step 209). Alternatively or additionally, incorporating air into the wet composition includes mechanically inducing air into the composition. In specific embodiments in which the dispersing step 206 includes substeps 206a-206c, incorporation of air into wet composition 208 comprises dispersing foaming agent(s) 205 into the polar solvent(s) 200 either before or during substep 206c (shown at 209a); and, at substep 212a, agitating and/or releasing pressure from the heated wet composition 208a.

At step 216, the aerated wet composition is processed into a thermal insulative composition. As indicated above, processing of the aerated wet composition includes drying the wet composition (step 216a) to a polar solvent content of from about 6% to about 10% by weight and, typically, to a density of from about 0.1 to about 0.5 g/cm³.

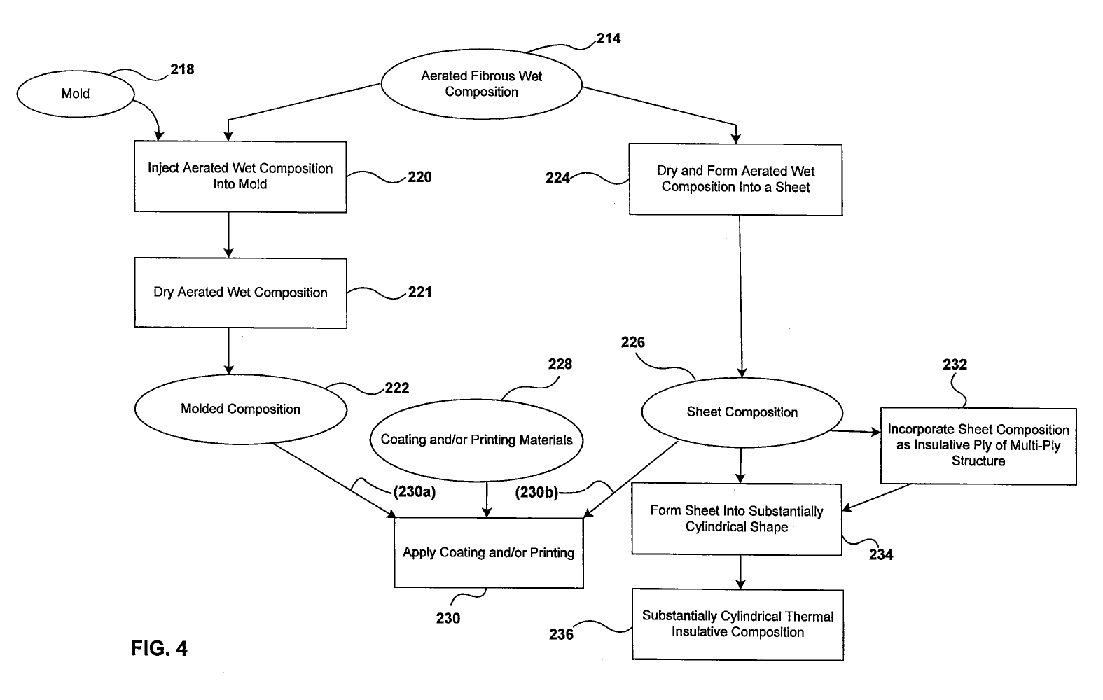

Processing of the aerated wet composition can further include the production of a molded or sheet composition. Such variations are schematically depicted in FIG. 4. In one embodiment, at step 220, the aerated fibrous wet composition is injected into a mold before the drying step 221, thereby producing a molded composition 222. In an alternative embodiment, at step 224, drying of the aerated wet composition includes forming the aerated wet composition into a sheet composition 226. Suitable drying techniques that can be used in such embodiments include, for example, air drying, convection oven drying, dryer can drying, impingement drying, and/or freeze drying. In either the production of a molded composition or formation of a sheet composition, coating and/or printing materials 228 can be applied to one or more surfaces of the composition (step 230a or 230b). As discussed previously, suitable coatings include, for example, polyethylene extrusion and wax coatings.

As further depicted in FIG. 4, in certain embodiments of a method in which a thermal insulative sheet composition is formed, the method further includes, at step 232, incorporating the sheet composition as the insulative ply of a multi-ply structure comprising an insulative ply and at least one other ply. As indicated previously, in specific variations, the sheet composition can be incorporated as the insulative ply of a two-ply structure comprising an insulative ply and a base ply; or as the center insulative ply of a three-ply structure comprising a center insulative ply and two outer base plies. Suitable base plies include, e.g., paper or paperboard.

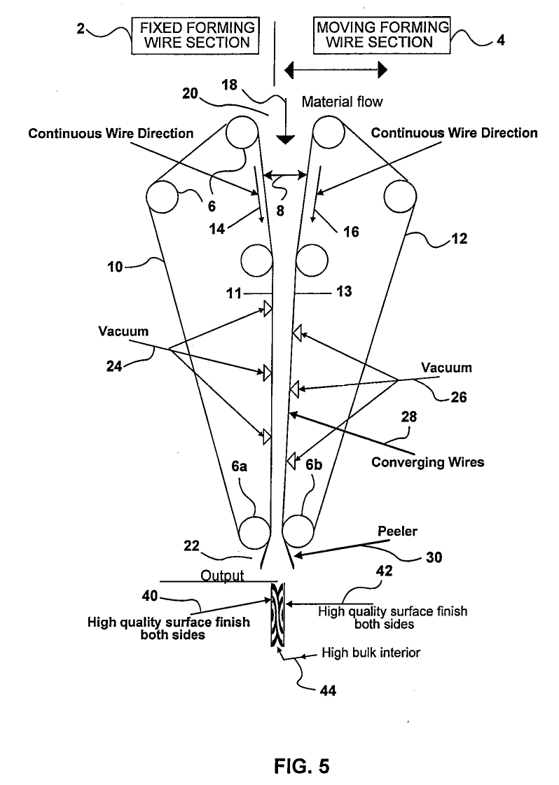

In certain preferred variations, forming the aerated fibrous wet composition into a sheet includes running the aerated wet composition through a twin-wire forming apparatus. One embodiment of a twin-wire forming apparatus is depicted in FIG. 5. A twin-wire forming apparatus in accordance with the present invention generally includes two forming wire sections 2 and 4 comprising forming wires 10 and 12, respectively. Each of forming wires 10 and 12 forms a closed loop, typically around a plurality of substantially cylindrical rollers 6, and is configured to run in continuous a wire direction (14 and 16, respectively). Forming wires 10 and 12 are spaced from each other so as to have a gap 8 between inner forming wire surfaces 11 and 13. Along the length of gap 8, continuous wire directions 14 and 16 run from proximal end 20 to distal end 22. Preferably, first and second forming wire sections 2 and 4 have the same feed rate along continuous wire directions 14 and 16.

In typical embodiments, the first and second forming wires converge from proximal end 20 to distal end 22 of the twin-wire apparatus, such that gap 8 gradually decreases from proximal end 20 to distal end 22. Alternatively, the first and second forming wires can be substantially parallel from proximal end 20 to distal end 22, such that gap 8 remains substantially the same along its length. Typically, gap 8 (i.e., the space between the first and second forming wires 2 and 4) is from about 0.5 mm to about 150 mm, more typically from about 0.5 mm to about 25 mm or from about 1 mm to about 20 mm. In some variations, gap 8 is from about 10 mm to about 25 mm at proximal end 20 and from about 4 mm to about 8 mm at distal end 22. In one specific embodiment, gap 8 is about 12 mm at 20 proximal end and about 6 mm at distal end 22. In the embodiment depicted in FIG. 5, forming wire section 2 is fixed while forming wire section 4 is movable along a plane substantially perpindular to inner forming wire surfaces 11 and 13, thereby allowing gap 8 to be either increased or decreased as desired. In alternative embodiments, both the first and second forming wire sections are movable in a plane substantially perpendicular to inner forming wire surfaces 11 and 13.

In a preferred embodiment of a method comprising running the aerated wet composition through a twin-wire forming apparatus as described herein, the method includes applying a vacuum perpendicularly to each of inner surfaces 11 and 13 of first and second forming wires 10 and 12, such that the aerated wet composition is pulled against each of the first and second forming wires. Application of vacuum pressure against the forming wires in this manner serves to compress the aerated wet composition into a layer against each of the first and second forming wires, each layer having a higher density than the aerated wet composition remaining in the interior of the sheet composition being formed. Application of the vacuum further promotes compression of the one or more polar solvents out of the fibers, thereby facilitating the drying process.

Accordingly, in certain embodiments, a twin-wire forming apparatus further includes means for subjecting the gap between the forming wire sections to opposing vacuum forces. In some such variations, the apparatus will include a first vacuum 24 configured to pull substantially perpendicularly toward inner surface 11 of the first forming wire 10; and a second vacuum 26 configured to pull substantially perpendicularly toward inner surface 13 of the second forming wire 12. Vacuums 24 and 26 typically include, for example, a vacuum pump or compressor fluidly coupled to a region adjacent to inner wire surfaces 11 and 13, respectively.

In typical variations, vacuum pressure as described herein is used while controlling the gap between the two forming wires—as the vacuum pulls the fibrous composition apart, the first and second forming wires 10 and 12 converge (decreasing gap 8, as shown by converging wires 28). The use of vacuum pressure in conjunction with a twin-wire forming apparatus as described above is different than conventional paper industry twin-wire forming machines, which use two wires to compress a wet fibrous composition to crush water out of the fibers. The use of vacuum pressure pulls the material of an aerated wet fibrous composition apart, yielding outer surfaces that are compressed and typically smooth (depicted in FIG. 5 as high quality surface finishes 40 and 42) while producing a high bulk (low density) interior 44.

In preferred embodiments, the twin-wire forming apparatus includes a peeler 30, which facilitates detachment of the sheet composition from the forming wires. Typically, peeler 30 lightly touches distal rollers 6a and 6b. Peeler 30 is used to detach the sheet composition during the initial run of the aerated wet fibrous composition through the twin-wire forming apparatus—once such detachment is achieved, the sheet composition produced at distal end 22 of the twin-wire forming apparatus continues to run off the first and second twin wires without continuing to wrap around the distal rollers 6a or 6b. Suitable materials for peeler 30 including, for example, polyethylene or sheet metal.

In certain aspects of the invention, following production of a thermal insulative sheet composition as described herein, at least a portion of the sheet composition is formed into a substantially cylindrical shape (shown as step 234) to produce a substantially cylindrical thermal insulative composition 236. Formation of a sheet composition into a cylindrical shape can be achieved using, for example, methods typically used in the paper industry for formation of cups and/or cup sleeves. Some such methods include, for example, wrapping the sheet around a substantially cylindrical mandrel.

### EXAMPLES

The following examples are offered to illustrate a few specific embodiments of thermal insulative products described herein, but not to limit the claimed invention.

### Example 1

A first exemplary embodiment of an insulative product is a molded thermal insulative composition form that could be used as an insulative liner in a cooler, beverage holder, or other similar holding device. Accordingly, the constituents for making the thermal insulative composition, on a per weight basis, are as follows:
a. 10.0 g VYSE® gelatin (stabilizing agent)
b. 10.0 g GPC® R-525 modified corn starch (stabilizing agent)
c. 15.0 g newsprint (fibrous material)
d. 1.0 g dish soap (foaming agent)
e. 500.0 g water (polar solvent)

The newsprint is dispersed in water to create a composition. The dispersion of the newsprint into the water is accomplished with a disintegrator, such as a Noram disintegrator, which does not damage the fibers while aggressively dispersing the fibrous material in the water. The other desired constituents listed above are then added and mixed into the composition for about two minutes. The composition is continually mixed and heated to 60° C. using a hot plate. The continual mixing and heating allows the constituents to readily disperse throughout the polar solvent and form a substantially homogeneous substance. This heated wet composition is then agitated and/or whipped using a mixer for approximately five minutes, which in turn cools the composition and entrains air into the composition to form an aerated wet composition. The resulting expanded, aerated wet composition has a volume that is greater than the original volume of the non-mixed original constituents.

The aerated wet composition is poured into a block mold with any excess composition being metered away. The wet composition remaining in the mold is freeze dried. Once the composition is dried, it becomes a molded fibrous form with an equilibrium moisture content less than 10% by weight at 50% relative humidity and 23° C. Additives can be added or additional processing of the insulative product may be performed to further customize and/or optimize certain features of the insulative product.

### Example 2

A second exemplary embodiment of an insulative product is a fibrous sheet that could be used as an insulative wrapping material. In the second exemplary embodiment, the constituents for making the thermal insulative composition, on a per weight basis, are as follows:
a. 6.0 g softwood pulp (fibrous material)
b. 4.0 g diluted dish soap (1% diluted solution) (foaming agent)
c. 10.0 g VYSE® gelatin (stabilizing agent)
d. 500.0 g water (polar solvent)

The softwood pulp is dispersed in water to create a composition using a disintegrator, as described above in the first example. The other desired constituents listed above are then added and mixed into the composition for about two minutes. The composition is continually mixed and heated to 60° C. using a hot plate. The continual mixing and heating allows the constituents to readily disperse throughout the polar solvent and form a substantially homogeneous substance. This heated wet composition is then agitated and/or whipped using a mixer for approximately five minutes, which in turn cools the wet composition and entrains air into the composition to form an aerated wet composition. The resulting aerated wet composition has a volume that is greater than the original volume of the non-mixed original constituents.

The aerated wet composition is made into a thermal insulative sheet composition by placing it onto a 100-mesh wire in a papermaking hand sheet mold. The composition is then dried in a convection oven at approximately 105° C. until it becomes a fibrous, lightweight, card stock and/or paper-like thermal insulative product having an equilibrium moisture content of less than 10% by weight at 50% relative humidity and 23° C. Additives can be added or additional processing of the thermal insulative product may be performed to further customize and/or optimize certain features of the thermal insulative product.

While the foregoing invention has been described in some detail for purposes of clarity and understanding, it will be clear to one skilled in the art from a reading of this disclosure that various changes in form and detail can be made without departing from the true scope of the invention. The above examples are provided to illustrate the invention, but not to limit its scope; other variants of the invention will be readily apparent to those of ordinary skill in the art and are encompassed by the claims of the invention. The scope of the invention should, therefore, be determined not with reference to the above description, but instead should be determined with reference to the appended claims along with their full scope of equivalents. All publications, references, and patent documents cited in this application are incorporated herein by reference in their entirety for all purposes to the same extent as if each individual publication or patent document were so individually denoted.

What is claimed is:

1. A thermal insulative composition comprising:
from about 50% to about 90% by weight of one or more stabilizing agents;
from about 10% to about 50% by weight of one or more fibrous materials; and
from about 6% to about 10% by weight of one or more polar solvents.

2. The composition of claim 1, which has a density of from about 0.1 to about 0.5 g/cm³.

3. The composition of claim 2, wherein the density is from about 0.1 to about 0.4 g/cm³.

4. The composition of claim 3, wherein the density is about 0.2 g/cm³.

5. The composition of claim 1, wherein the one or more stabilizing agents comprises at least one of a polysaccharide and a protein.

6. The composition of claim 5, wherein the one or more stabilizing agents comprises the polysaccharide.

7. The composition of claim 6, wherein the polysaccharide is an agar, an alginate, a pectin, a carrageenan, or a starch.

8. The composition of claim 7, wherein the polysaccharide is a starch.

9. The composition of claim 5, wherein the protein is a gelatin.

10. The composition of claim 1, wherein the one or more fibrous materials comprises at least one of a naturally occurring fibrous material and a synthetic fibrous material.

11. The composition of claim 10, wherein the one or more fibrous materials comprises the naturally occurring fibrous material.

12. The composition of claim 11, wherein the naturally occurring fibrous material is refined.

13. The composition of claim 11, wherein the naturally occurring fibrous material is unrefined.

14. The composition of claim 11, wherein the naturally occurring fibrous material is a softwood fiber, a hardwood fiber, a non-woody plant fiber, or an animal fiber.

15. The composition of claim 14, wherein the naturally occurring fibrous material is a non-woody plant fiber.

16. The composition of claim 15, wherein the non-woody plant fiber is a cotton fiber, a jute fiber, a flax fiber, a ramie fiber, a bamboo fiber, a bagasse fiber, a kenaf fiber, a straw fiber, an arundo donax fiber, or a hemp fiber.

17. The composition of claim 10, wherein the one or more fibrous materials comprises the synthetic fibrous material.

18. The composition of claim 17, wherein the synthetic fiber is a carbon fiber, a polyester fiber, a nylon fiber, a rayon fiber, a glass fiber, or an aramid fiber.

19. The composition of claim 1, wherein the one or more polar solvents comprises at least one of an alcohol and water.

20. The composition of claim 19, wherein the one or more polar solvents comprises water.

21. The composition of claim 1, which comprises
about 53% by weight of the one or more stabilizing agents;
about 40% by weight of the one or more fibrous materials; and
about 7% by weight of the one or more polar solvents.

22. The composition of claim 1, further comprising up to about 2% by weight of one or more foaming agents.

23. The composition of claim 22, wherein the one or more foaming agents comprises at least one of an anionic surfactant, a cationic surfactant, and a nonionic surfactant.

24. The composition of claim 23, wherein the one or more foaming agents comprises the anionic surfactant.

25. The composition of claim 24, wherein the anionic surfactant is a soap or a fatty acid salt.

26. The composition of claim 1, which does not comprise a foaming agent.

27. The composition of claim 1, further comprising from about 0.1% to about 5% by weight of one or more additives.

28. The composition of claim 27, wherein the one or more additives comprises at least one of a wet strength additive, a dry strength additive, a water repellant, a glue, a chemical foaming agent, a fungicide a fire retardant, a dye, and a sizing agent.

29. The composition of claim 1, which is a molded composition or a sheet composition.

30. The composition of claim 29, further comprising at least one of a coating and a printing applied to a surface of the composition.

31. The composition of claim 30, wherein the coating is a polyethylene extrusion or a wax coating.

32. The composition of claim 29, which is a sheet composition.

33. The composition of claim 32, which has a high-bulk interior and a smooth surface finish on both sides.

34. The composition of claim 32, wherein the sheet composition is the insulative ply of a multi-ply structure comprising an insulative ply and at least one other ply.

35. The composition of claim 34, wherein the sheet composition is
(a) the insulative ply of a two-ply structure comprising an insulative ply and a base ply; or
(b) the center insulative ply of a three-ply structure comprising a center insulative ply and two outer base plies.

36. The composition of claim 35, wherein the base ply or (a) and the outer base plies of (b) are paper or paperboard.

37. The composition of claim 1, which is an alterable stiffness insulative material.

38. The composition of claim 37, which is a sheet composition.

39. The composition of claim 38, which has a high-bulk interior and a smooth surface finish on both sides.

40. The composition of claim 38, wherein the sheet composition is a sheet produced on a continuous run machine and has a machine direction (MD) and a cross direction (CD).

41. The composition of claim 40, wherein the taber stiffness is between about 100 to about 450 g-cm in the machine direction and between about 40 to about 230 g-cm in the cross direction.

42. The composition of claim 41, wherein the MD/CD taber stiffness is selected from the group consisting of:
(a) an MD stiffness of between about 110 and about 160 g-cm with a CD stiffness of between about 50 and about 80 g-cm;
(b) an MD stiffness of between about 120 and about 180 g-cm with a CD stiffness of between about 55 and about 95 g-cm;
(c) an MD stiffness of between about 150 and about 215 g-cm with a CD stiffness of between about 60 and about 105 g-cm;
(d) an MD stiffness of between about 185 and about 250 g-cm with a CD stiffness of between about 75 and about 125 g-cm;
(e) an MD stiffness of between about 210 and about 280 g-cm with a CD stiffness of between about 85 and about 150 g-cm;
(f) an MD stiffness of between about 260 and about 360 g-cm with a CD stiffness of between about 105 and about 185 g-cm; and
(g) an MD stiffness of between about 340 and about 450 g-cm with a CD stiffness of between about 135 and about 230 g-cm.

43. The composition of any one of claims 32, 37, and 40, which has a thickness of between about 0.5 mm and about 150 mm.

44. The composition of any one of claims 32, 37, and 40, which has a thickness of between about 1 mm and about 4 mm.

45. The composition of claim 1, which has a nominal weight of from about 100 to about 400 g/m².

46. The composition of claim 45, which has a nominal weight of from about 150 to about 300 g/m².

47. A thermal insulative container or container sleeve comprising the thermal insulative composition of claim 1.

48. The thermal insulative container or container sleeve of claim 47 comprising the sheet composition of any one of claims 32, 37, and 40.

49. An aerated wet composition comprising:
from about 4% to about 7% by weight of one or more stabilizing agents;
from about 1% to about 4% by weight of one or more fibrous materials;
from about 90% to about 95% by weight of one or more polar solvents; and
a volume of gas, equal to from about 20% to about 70% by volume;
wherein the aerated wet composition has a density of from about 0.7 to about 0.3 g/cm³.

50. The composition of claim 49, wherein the one or more stabilizing agents comprises at least one of a polysaccharide and a protein.

51. The composition of claim 50, wherein the polysaccharide is an agar, an alginate, a pectin, a carrageenan, or a starch.

52. The composition of claim 49, wherein the one or more fibrous materials comprises at least one of a naturally occurring fibrous material and a synthetic fibrous material.

53. The composition of claim 52, wherein the naturally occurring fibrous material is a softwood fiber, a hardwood fiber, a non-woody plant fiber, or an animal fiber.

54. The composition of claim 53, wherein the non-woody plant fiber is a cotton fiber, a jute fiber, a flax fiber, a ramie fiber, a bamboo fiber, a bagasse fiber, a kenaf fiber, a straw fiber, an arundo donax fiber, or a hemp fiber.

55. The composition of claim 52, wherein the synthetic fiber is a carbon fiber, a polyester fiber, a nylon fiber, a rayon fiber, a glass fiber, or an aramid fiber.

56. The composition of claim 49, wherein the one or more polar solvents comprises at least one of an alcohol and water.

57. The composition of claim 49, further comprising up to about 2% by weight of one or more foaming agents.

58. The composition of claim 49, which does not comprise a foaming agent.

59. The composition of claim 49, which comprises
about 4% by weight of the one or more stabilizing agents;
about 3% by weight of the one or more fibrous materials; and
about 93% by weight of the one or more polar solvents.

60. A method of making a thermal insulative composition as in claim 1, the method comprising:
drying an aerated wet composition as in claim 46 to a polar solvent content of from about 6% to about 10% by weight.

61. The method of claim 60, wherein the aerated wet composition is dried to a density of from about 0.1 to about 0.5 g/cm³.

62. The method of claim 60, wherein the drying step comprises at least one of air drying, convection oven drying, and freeze drying.

63. The method of claim 60, further comprising making the aerated wet composition, said making of the aerated wet composition comprising
dispersing the one or more stabilizing materials and the one or more fibrous materials in the one or more polar solvents to produce a fibrous wet composition; and
incorporating air into the fibrous wet composition.

64. The method of claim 63, wherein incorporating air into the fibrous wet composition comprises the use of one or more foaming agents.

65. The method of claim 63, wherein incorporating air into the fibrous wet composition comprises mechanically inducing air into mixture.

66. The method of claim 63, wherein the dispersing step comprises
(a) dispersing the one or more fibrous materials in the one or more polar solvents to produce a fibrous material/polar solvent mixture;
(b) heating the mixture of (a); and
(c) between the beginning and end of the heating step of (b), continually mixing and/or applying pressure to the mixture of (a) while dispersing into the mixture the one or more stabilizing agents.

67. The method of claim 66, wherein the incorporation of air into the fibrous wet composition comprises
dispersing one or more foaming agents into the one or more polar solvents before or during step (c) and
agitating and/or releasing pressure from the heated mixture of (c).

68. The method of claim 60, further comprising injecting the aerated wet composition into a mold before the drying step, thereby producing a molded composition.

69. The method of claim 68, further comprising at least one of
(i) applying a coating to the molded composition and (ii) applying a printing to the molded composition.

70. The method of claim 60, wherein the drying of the aerated wet composition further comprises forming the composition into a sheet.

71. The method of claim 70, wherein the drying step comprises at least one of air drying, convection oven drying, dryer can drying, impingement drying, and freeze drying.

72. The method of claim 70, further comprising at least one of (i) applying a coating to the sheet composition and (ii) applying a printing to the sheet composition.

73. The method of claim 72, wherein the coating comprises at least one of a polyethylene extrusion and a wax.

74. The method of claim 70, further comprising incorporating the sheet composition as the insulative ply of a two-ply structure comprising an insulative ply and a base ply.

75. The method of claim 74, wherein the base ply comprises paper or paperboard.

76. The method of claim 70, further comprising incorporating the sheet composition as the center insulative ply of a three-ply structure comprising a center insulative ply and two outer base plies.

77. The method of claim 76, wherein at least one or the two outer base plies comprises paper or paperboard.

78. The method of claim 70, wherein the forming of the aerated wet composition into a sheet comprises running the aerated wet composition through a twin-wire forming apparatus, the twin-wire forming apparatus comprising first and second forming wire sections comprising first and second forming wires, respectively, wherein the first and second forming wires have a gap therebetween, and wherein the gap gradually decreases from the proximal end to the distal end of the twin-wire forming apparatus.

79. The method of claim 78, further comprising applying a vacuum perpendicularly to each of the first and second forming wires, wherein the aerated wet composition is pulled against each of the first and second forming wires, thereby compressing the aerated wet composition into first and second layers against each of the first and second forming wires, respectively, the first and second layers having a higher density than the aerated wet composition remaining between the first and second layers.

80. The method of claim 70, further comprising forming at least a portion of the sheet into a substantially cylindrical shape.

81. The method of claim 80, wherein forming at least a portion of the sheet into a substantially cylindrical shape comprises wrapping the sheet around a substantially cylindrical mandrel.

82. An apparatus for forming a sheet composition having a high bulk interior and a surface finish on both sides, the apparatus having a proximal end and a distal end, the apparatus comprising:
first and second forming wire sections comprising first and second forming wires, respectively, wherein the first and second forming wires have a continuous wire direction from the proximal end to the distal end, wherein the inner surfaces of the first and second forming wires are spaced from each other so as to define a gap there between, and wherein said gap gradually decreases from the proximal end to the distal end.

83. The apparatus of claim 82, wherein the first forming wire section is fixed and the second forming wire section is movable so as to allow the gap between the first and second forming wires to be increased or decreased.

84. The apparatus of claim 82, wherein each of the first and second forming wire sections is movable so as to allow the gap between the first and second forming wires to be increased or decreased.

85. The apparatus of claim 82, further comprising means for subjecting the gap to opposing vacuum forces, said means comprising a first vacuum configured to pull perpendicularly toward a surface of the first forming wire and a second vacuum configured to pull perpendicularly toward a surface of the second forming wire.

86. The apparatus of claim 82, wherein the gap between the first and second forming wires is from about 0.5 mm to about 150 mm.

87. The apparatus of claim 82, wherein the gap between the first and second forming wires is from about 0.5 mm to about 25 mm.

88. The apparatus of claim 82, wherein the gap between the first and second forming wires is from about 10 mm to about 25 mm at the proximal end and from about 4 mm and about 8 mm at the distal end.

89. The apparatus of claim 82, wherein the gap between the first and second forming wires is about 12 mm at the proximal end and about 6 mm at the distal end.
